(19) United States
(12) Patent Application Publication
(10) Pub. No.: US 2006/0129505 A1
(43) Pub. Date: Jun. 15, 2006

(54) Method for equipping a franking machine with a weighing unit and franking arrangement equipped thereby

(76) Inventor: Christoph Kunde, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/280,574

(22) Filed: Nov. 16, 2005

(30) Foreign Application Priority Data
Nov. 16, 2004 (DE) 10 2004 055 346.7

(51) Int. Cl. G01G 19/413

(52) U.S. Cl. 705/407

(57) ABSTRACT

In a method for equipping (in particular retrofitting) a franking machine with a weighing unit, the weighing unit is connected with a processing device of the franking machine in a connection step, the weighing unit calibrated for a pre-calibration site. The connection of the weighing unit with the processing device is detected in a detection step that follows the connection step and a calibration of the weighing unit for the site of the franking machine ensues using a calibration value associated with the franking machine in a calibration step that follows the detection step

### BACKGROUND OF THE INVENTION

1. Field of the Invention

The present invention concerns a method for equipping (in particular for retrofitting) a franking machine with a weighing unit, of the type wherein the weighing unit is connected with a first processing device of the franking machine in a connection step. The invention furthermore concerns a franking arrangement in which the inventive method can be implemented.

2. Description of the Prior Art

For conventional franking machines, weighing units (such as postal scales or the like) that can be connected with them are normally available that supply measurement values to the franking machine in order to automatically determine the correct franking value for the weighed postal item using rate tables of a postal carrier.

Conventional franking machines are frequently delivered to the customers without a ready-to-use, mounted postal scale. Franking systems for larger mail volumes are modularly designed with a letter separator, scale, franking machine, stacker etc. as separate units and are therefore frequently first assembled on site at the customer. In case of franking machines for smaller and average mail volumes, frequently these are delivered without a mounted postal scale. If necessary, the customer can then order and retrofit the scale at a later point in time.

The franking machine and the associated weighing unit are normally centrally produced at one or a few production sites, then shipped to sites for the franking machine that are located arbitrarily far away from the production site. A problem is that, depending on the geographic latitude of the site of the franking machine, the acceleration due to gravity can differ significantly at the production location of the weighing unit. In the typically-used electronic weighing units, this can have a significant influence on the output measurement result and therewith on the calculated franking value. In order to avoid erroneous frankings, it is therefore necessary to calibrate the weighing unit for the site of the franking machine.

This calibration of the weighing unit for the site of the franking machine typically occurs either on site by the customer or a service technician, by conducting test measurements with test masses and making corresponding inputs on the franking machine or the weighing unit. This method has the disadvantage of being relatively complicated. It is also error-prone and susceptible to manipulation, since a deliberate or unknowing false calibration leads to false measurements.

Alternatively, a calibration for the site of the franking machine can already be conducted at the production location before shipment of the weighing unit. This variant has the disadvantage that the later site of the franking machine must already be known at this point in time. This has the consequence that either the delivery times must be increased because the calibration can only be conducted when the order exists, or weighing units for different sites of the franking machine must be stored, increasing the storage expenditure.

For scales, it is generally known to conduct a calibration for the site of the scale on site without the use of test masses. Thus, for example, it is known from DE 44 08 232 A1 to determine the position of the scale using a satellite-supported positioning of the scale. A correction factor, with which the scale calibrated for an arbitrary production location can then be recalibrated for its current site is then determined from the detected position of the scale. In fact, a reliable calibration for the site of the scale is herewith possible, but this entails a significant expense for components in the scale to communicate with the satellite.

In order to prevent the expenditure for such a satellite positioning system, it is known from DE 196 19 854 A1 to provide the scale with a modem or the like via which a communication connection to a data center is established for calibration of the scale over a telephone network. The data center then determines the position of the scale from a location prefix of the telephone network transmitted in the framework of the communication connection. Using this position, the data center then determines a correction factor that is transmitted to the scale and is used in the scale for calibration of the scale for its site. This method has the disadvantage that a communication connection must always first be established ad hoc for calibration of the scale before the calibration can ensue.

### SUMMARY OF THE INVENTION

An object of the present invention is to provide a method and a franking arrangement of the type cited above that do not exhibit, or exhibit only to a lesser degree, the disadvantages cited above, and which in particular enable a fast and simple, site-dependent calibration of the weighing unit connected to the franking machine.

The present invention is based on the recognition that a fast and simple, site-dependent calibration of the weighing unit connected to the franking machine is possible when the weighing unit calibrated for a pre-calibration site is connected with a processing device in a connection step. The connection of the weighing unit with the first processing device is then detected in a detection step that follows the connection step. In a final calibration step that follows the detection step, a calibration of the weighing unit for the site of the franking machine finally ensues using a calibration value associated with the franking machine.

The use of a weighing unit calibrated for the pre-calibration site enables a calibration value with which first measurement signals of the weighing unit, pre-calibrated for the pre-calibration site can then be recalculated in order to obtain, in a simple manner, second measurement signals calibrated for the site of the franking machine.

The use of a calibration value associated with the franking machine thereby enables a simple and fast calibration of the weighing unit without an elaborate position determination of the weighing unit having to be conducted upon connection of the weighing unit. The association of the calibration value with the franking machine has the advantage that the site of the franking machine is normally known anyway with sufficient precision due to the association of the franking machine with specifically-assigned delivery locations for the postal items franked therewith. A further, separate site determined also for the weighing unit is unnecessary, such that a fast calibration of the weighing unit is possible.

In particular it is possible to load the calibration value into the franking machine before the connection of the weighing unit with the franking machine due to its association with the franking machine. The weighing unit can then be calibrated immediately using this calibration value that is present in the franking machine, without further position determination or contact attempts with a remote data center.

The franking machine can already receive the calibration value upon production or its delivery to the customer. The calibration value is preferably transmitted from a remote data center to the franking machine in a transmission step, such that the franking machine does not already have to be prepared at the points in time, but only as needed.

The transmission step can ensue at an arbitrary point in time. In particular it can ensue after the detection step, but the transmission step preferably precedes the detection step. The calibration for the site of the franking machine can ensue immediately after detection of the weighing unit, without a repeated communication being necessary for transmission of the calibration value. As mentioned, this is possible due to the association of the calibration value with the franking machine.

If the site of the franking machine is known with sufficient precision, it can suffice that a single calibration value is transmitted in the transmission step. In other variants of the inventive method, however, multiple calibration values (including the aforementioned calibration value, as a first calibration value) are transmitted to the franking machine in the transmission step and the first calibration value is selected from this multiple of calibration values in a selection step. This selection can ensue by means of arbitrary, automatic processes with which the sufficiently exact position of the franking machine (and therein with the position of the scale) can be determined.

The selection of the calibration value preferably ensues using an input of a user of the franking machine. For example, a number of site regions are displayed to the user on an output device (such as a display, etc.) for selection. With a corresponding input, the user then selects the one in which the franking machine is located. A calibration value is associated with each site region, such that a selection of the calibration value then also ensues by the selection of the site region.

The partitioning of the site regions can be selected to be arbitrarily fine divided. Thus, for example, states, federal states, postal code regions or telephone prefix regions etc. can be provided as a division. The required refinement of the partitioning ultimately conforms only to the precision to be achieved of the measurement results of the weighing unit, and therewith to the tolerable error of the calibration.

The association of the calibration value with the franking machine can ensue in an arbitrary manner. Preferably this ensues by an identification associated with the franking machine, this identification being also associated with the first calibration value. The calibration value is then preferably determined using an identification associated with the franking machine. For example, the position of the franking machine is known with sufficient precision, and with it the calibration value belonging to this position, thus can be determined in a data center using the identification of the franking machine, for example the serial number of the franking machine.

In preferred variants of the inventive method, the identification of the franking machine is a one-time and unambiguous identification with which precisely one specific franking machine can be identified. However, it is understood that in other cases a less precise identification of the franking machine can also suffice. If, for example, region-specific (for example country-specific) variants are provided for specific franking machines, an identification of the region association (for example the identification of the country variant) can possibly also suffice for the association of the suitable first calibration value with the respective franking machine.

The communication of the calibration value to the franking machine can ensue in an arbitrary suitable manner. The calibration value is preferably communicated to the franking machine together with a postage rate table provided for calculation of franking values. This has the advantage that this postage rate table must normally be transmitted to the franking machine anyway in order to enable the calculation of franking values, such that a further, separate communication for transmission of the first calibration value is not necessary. The transmission proves to be particularly simple when the calibration value is transmitted integrated into the postage rate table.

Since such postage rate tables are also regularly exchanged, it is additionally possible to effect an update of the calibration with changed calibration values in a simple manner at specific points in time, insofar as this is necessary. A more precise position determination thus can be introduced in a simple manner. A site change of the franking machine, for example in the framework of a relocation or the like, can likewise be taken into account.

The integration of the calibration value into the postage rate table can ensue in an arbitrary suitable manner. The postage rate table preferably contains a calibration table that in turn contains the calibration value.

The calibration value can be an arbitrary suitable value which can be used to convert the measurement signals of the pre-calibrated weighing unit into measurement signals calibrated for the site of the franking machine. In preferred variants of the inventive method, the calibration value is a gravitational constant using which a conversion of the measurement values represented by the measurement signals of the weighing unit into weight values ensues. Alternatively, the calibration value can be a correction factor for a gravitational constant with which a corresponding conversion ensues.

The calibration of the weighing unit can ensue in any suitable manner. In the present invention, it is not necessary that the measurement results that are correct for the site of the franking machine be directly output by the weighing unit. A conversion corresponding to the calibration can ensue, for example, in the franking machine.

In preferred variants of the inventive method, the calibration of the weighing unit ensues in that the weighing unit supplies measurement signals calibrated for the pre-calibration site to the processing device, and the processing device converts the first measurement signals received from the weighing unit into second measurement signals calibrated for the site of the franking machine using the calibration value. Alternatively, the weighing unit using the calibration value directly converts the first measurement signals calibrated for the pre-calibration site into second measurement signals calibrated for the site of the franking machine.

As mentioned above, the calibration can be repeated. The calibration step for updating the calibration is preferably repeated at least once, triggered by at least one predeterminable event. Such a predeterminable event can be an arbitrary temporal or non-temporal event. For example, the event can be reaching specific, predeterminable points in time. The event can likewise be the occurrence of a specific, predeterminable operating state of the franking machine or of the weighing unit. The calibration can be repeated, for example, at every n-th activation (with n=1, 2, 3 etc.) of the franking machine and/or of the weighing unit. The event can also be a specific input of a user or from a remote data center.

The present invention furthermore concerns a franking arrangement with a franking machine and a weighing unit that can be connected with the franking machine, whereby the franking machine includes a processing device with which the weighing unit can be connected. According to the invention, the weighing unit is pre-calibrated for a pre-calibration site at the point in time of the connection with the first processing device. The processing device detects the connection of the weighing unit with the first processing device. The first processing device and/or the weighing unit is furthermore designed for calibration of the weighing unit for the site of the franking machine using a calibration value associated with the franking machine.

The advantages and variants of the inventive methods outlined above can be realized to the same degree with this franking arrangement.

The franking machine advantageously has a memory connected with the processing device, in which the calibration value is stored. In variants of the inventive franking arrangement with the described selection possibility of the calibration value, a number of calibration values including the aforementioned calibration value as a first calibration value are then stored in the memory. The processing device is then designed for selection of the first calibration value from these multiple calibration values. The processing device is preferably designed for selection of the first calibration value using input information of a user of the franking machine.

In an embodiment of the inventive franking arrangement, a remote data center is provided that can be connected with the franking machine via a telecommunication connection and is fashioned for transmission of the first calibration value to the franking machine. The calibration of the franking machine can hereby be centrally controlled in a particularly simple manner. The data center is preferably designed for determination of the calibration value using an identification associated with the franking machine.

Furthermore, the data center is designed for the communication (described above) to the franking machine of the first calibration value together with a postage rate table provided for calculation of franking values. The data center is in turn preferably designed for communication of the first calibration value integrated into the postage rate table.

The postage rate table is stored with the calibration value in the memory. For this purpose, the postage rate table preferably contains a calibration table that contains at least the first calibration value.

In order to realize the calibration described above, the weighing unit can supply to the processing device, first measurement signals calibrated for the pre-calibration site, and the processing device can be fashioned for converting, using the calibration value, the first measurement signals into second measurement signals calibrated for the site of the franking machine. Alternatively, the processing device can be fashioned for relay of the calibration value to the weighing unit, and the weighing unit can be fashioned for recalculating, using the calibration value, the first measurement signals into second measurement signals calibrated for the site of the franking machine.

In order to realize the described, at least one-time repetition of the calibration, the processing device and/or the weighing unit can be fashioned for at least one-time repetition (triggered by at least one predeterminable event) of the calibration of the weighing unit for the site of the franking machine.

The present invention furthermore concerns a franking machine that exhibits the features of the franking machine described in connection with the inventive franking arrangement. The invention furthermore concerns a weighing unit that exhibits the features of the weighing unit described in connection with the inventive franking arrangement.

### DESCRIPTION OF THE DRAWINGS

FIG. 1 is a schematic illustration of a preferred embodiment of the inventive franking arrangement in which the inventive method can be implemented.

FIG. 2 is a flowchart of a preferred embodiment of the inventive method for equipping a franking machine with a weighing unit, which method can be implemented in the franking arrangement of FIG. 1.

FIG. 3 is a flowchart of a further preferred embodiment of the inventive method for equipping a franking machine with a weighing unit, which method can be implemented in the franking arrangement of FIG. 1.

### DESCRIPTION OF THE PREFERRED EMBODIMENTS

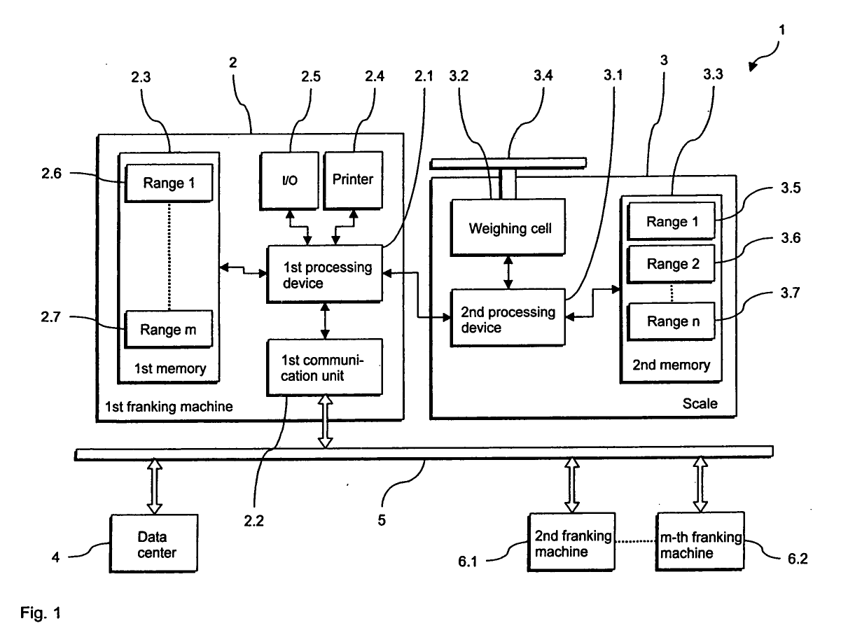

FIG. 1 is a schematic illustration of a preferred embodiment of the inventive franking arrangement 1 in which the inventive method can be implemented.

The franking arrangement 1 includes a franking machine 2 with a first processing device 2.1 as well as a communication unit in the form of a modem 2.2, a first memory 2.3, a printing device in the form of a printer 2.4 and an input and output device 2.5, all of which are connected with the first processing device 2.1.

Furthermore, the franking arrangement 1 has a weighing unit in the form of a scale 3. This scale 3 has a second processing device 3.1 as well as a weighing cell 3.2 and a second memory 3.3 that are each connected with the second processing device 3.1. The weighing cell 3.2 is connected with a platform 3.4 on which postal items can be placed for weighing.

The franking arrangement 1 also includes a remote data center 4 that can be connected with the modem 2.2 of the franking machine 2 via a telecommunication network 5. The data center 4 can be connected via the telecommunication network 5 with further franking machines 6.1, 6.2 that are at least in part designed like the franking machine 2.

The franking machine 2 is used by a user to provide postal items such as letters, packages etc. with franking imprints by means of the printer 2.4, the franking imprints being in compliance with a format accepted by a postal carrier. For this purpose, among other things the correct postage value that is to be used for the appertaining postal item must be determined. In addition to depending on other parameters such as size, shipping type, shipping location etc., this depends on the mass of the postal item (also designated as weight). Different mass classes (also designated as weight classes) are normally provided that entail different postage values.

The user can determine the mass or weight class of the respective postal item, in an arbitrary manner and enters this into the franking machine 2 via the input and output device 2.5, for example an interface with a keyboard and display. The first processing device 2.1 then determines the correct postage value from the parameters of the postal item and correspondingly activates the printer for generation of the franking imprint. A so-called postage rate table of the appertaining postal carrier is used in the determination of the postage value. From the postage rate table the correct postage value, among other things, can be identified using the selected mass or weight class.

In order to simplify the generation of the franking imprint, after its delivery to a customer on site the franking machine 2 can be equipped or retrofitted at the customer with the scale 3, by the scale 3 being connected with the franking machine 2. The scale 3 supplies to the first processing device 2.1 a measurement value representative for the weight or the mass of the postal item placed thereon. Using this measurement value, the first processing device 2.1 can then automatically effect the classification of the postal item in the corresponding weight class without an input by the user of the franking machine 2 being necessary.

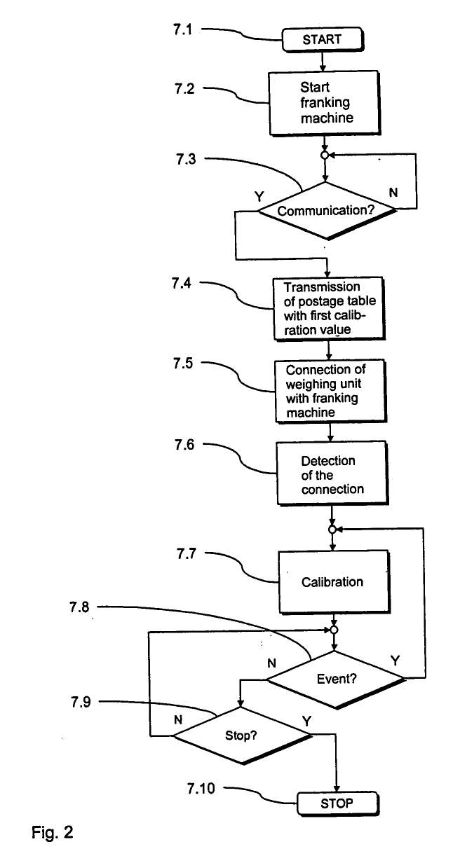

In the following, a preferred embodiment of the inventive method for equipping a franking machine with a weighing unit is described with reference to FIGS. 1 and 2, which method can be implemented in the franking arrangement 1.

The method process is initially started in a step 7.1. The franking machine 2 is started in a step 7.2 and proceeds through an initialization routine (which need not be discussed in detail here). After the initialization routine, the franking machine 2 attempts to establish a connection with the data center 4 via its modem 2.2. This can possibly ensue only at a later point in time after the activation of the franking machine, via a corresponding automatic function call or a function call initiated by the user. In step 7.3, the first processing device 2.1 tests whether a connection with the data center 4 has been successfully established.

If this is the case, in a transmission step a postage rate table that is stored in a first area 2.6 of the first memory 2.3 is transmitted from the data center 4 to the franking machine 2 in addition to other data. In addition to the association ranges for the postage value, among other things this postage rate table also contains a calibration table. This calibration table contains at least one calibration value that, as is explained in further detail in the following, is used for later calibration of the scale 3.

The postage rate table with the calibration table is selected by the data center 4 using an identification of the franking machine 2 transmitted by the franking machine 2 in the framework of the communication. For this purpose, the postage rate table, in a databank of the data center 4, is linked with this identification of the franking machine 2, such that the appertaining postage rate table, the calibration table and with this also the calibration values contained therein are associated with the franking machine 2.

This association of the calibration values with the franking machine 2 and not with a specific scale enables the calibration values to already be transmitted before the connection of a scale to the franking machine 2. Furthermore, it is not necessary to effect such an association for the scales. The production expenditure for the scale is thus significantly simplified, since it must only be calibrated for the pre-calibration site, independent of its later use site, and no special precautions must be made for its later identification and localization of the calibration. An association of the calibration values must in fact be effected for the franking machine, but this is designed very simply and does not especially increase the expenditure since a sufficiently precise localization is necessary for the franking machine anyway for other reasons. A reduction of the expenditure for the calibration is thus achieved overall.

As soon as the postage rate table has been successfully loaded into the franking machine 2, it can be used for franking. In other variants of the present invention, the franking machine is already delivered with a corresponding postage rate table. The transmission step can then be omitted.

The franking machine 2 can initially be delivered to the customer without the scale 3, or can be operated by the customer for a specific time without the scale 3. In this case, as described above the user must select or enter into the franking machine 2 the mass or, respectively, weight class of the respective postal item. The scale 3 can, however, likewise be connected to the franking machine 2 before a first franking.

In a connection step 7.4, the scale 3 is connected to the franking machine 2 so that the first processing device 2.1 and the second processing device 3.2 are connected with one another via interfaces (not shown in detail).

In a detection step 7.5, the first processing device 2.1 then detects that the scale 3 has been connected to the franking machine 2. For this, the first processing device 2.1 can, for example, address the interface to the scale 3 at regular intervals and check whether a corresponding signal is present at this interface, this signal indicating that the scale 3 has been connected.

In the delivery state, the scale 3 is pre-calibrated for a pre-calibration site, for example its production site. This means that, at this pre-calibration site, the second processing device 3.1 outputs a signal at its interface to the franking machine 2, this signal representing the correct (at this pre-calibration site) weight of the postal item placed on the platform. Using pre-calibration data, this signal is determined by the second processing device from the measurement signals delivered from the weighing cell 3.2. This pre-calibration data were determined in the framework of the pre-calibration and stored in a first region 3.5 of the second memory 3.3.

The second processing device 3.1 calculates the mass mᵥ of a postal item placed on the platform at the pre-calibration site according to the following equation:

$${m}_{V} = {m}_{K} \cdot ( \frac{s - {s}_{0}}{{s}_{K} - {s}_{0}} ) , \qquad ( 1 )$$

wherein: m_{K}: calibration mass with which the scale was calibrated;
s: output signal of the weighing cell given a resting mass mᵥ;
s₀: output signal of the weighing cell at the zero point, i.e. without resting mass;
s_{K}: output signal of the weighing cell at the end point, i.e. given a resting calibration mass.

Among other things, the values m_{K} (calibration mass), s₀ (output signal off the weighing cell at the zero point) and s_{K} (output signal of the weighing cell at the end point) represent pre-calibration data and are therefore stored in a first area 3.5 of the second memory 3.3 of the scale 3.

Further pre-calibration data that are likewise stored in a first area 3.5 of the second memory 3.3 are the date and the number of the calibration as well as the value of the gravitational constant gᵥ at the pre-calibration site.

Finally, still further data regarding the scale 3 are stored in the first memory. Among other things, an identification of the manufacturer of the scale, the manufacturing date of the scale, an identification of the scale (for example a serial number), type or version information of the scale etc. can be included in the further data.

A calibration of the scale for the site of the franking machine 2 then ensues in a calibration step 7.6. For this purpose, a first calibration value is extracted by the first processing device 2.1 from the calibration table stored in the first area 2.6 of the first memory 2.3 and transmitted to the second processing device 3.1, which then stores this in a second area 3.6 of the second memory 3.3.

In the present case, this first calibration value is the gravitational constant g_{FM} at the site of the franking machine 2. By means of this gravitational constant g_{FM} for the site of the franking machine 2, the second processing device 3.1 can then calculate, from the signals of the weighing cell and from the pre-calibration data stored in the first area 3.5 of the second memory 3.3, the correct mass m_{FM} of a postal item placed on the platform 3.4 at the site of the franking machine 2.

In other words, the calibration ensues by the second processing device 3.1 converting the first measurement signals (calibrated for the pre-calibration site) of the weighing cell 3.2 into second measurement signals calibrated for the site of the franking machine using the first calibration value. These second measurement signals are then relayed to the first processing device 2.1 for use in the determination of the postage value using the postage rate table.

In other variants of the present invention, the calibration ensues in that the second processing device 3.1 supplies to the first processing device 2.1 the first measurement signals calibrated for the pre-calibration site, and the first processing device 2.1 converts these first measurement signals into second measurement signals calibrated for the site of the franking machine using the first calibration value.

Alternatively the second processing device 3.1 can be merely an analog-digital converter that relays the digitized signals of the weighing cell and the pre-calibration data from the second memory to the first processing device 2.1. Using these data, the first processing device 2.1 then conducts all calculations necessary to determine the correct measurement value m_{FM}.

In other variants of the present invention, instead of a gravitational constant for the site of the franking machine, only a correction factor of the gravitational constant at the pre-calibration site can be provided, this correction factor being determined for the site of the franking machine. An arbitrary different value can naturally likewise also be used which allows the determination of correct measurement values for the site of the franking machine.

According to the present invention, the calibration table can contain one or more calibration values. If only one calibration value is provided, in the calibration step 7.7 this is loaded into the scale 3 as a first calibration value in the manner described above without any further measures.

However, if a number of calibration values are contained in the calibration table, a selection of the first calibration value ensues in a selection step of the calibration step 7.7. For this purpose, the user can be prompted via the display of the input and output device 2.5 to select a matching calibration value for the site of the franking machine 2 as a first calibration value. For this, for example, the user can be prompted to enter information about the location of the franking machine. This can be, for example, specification of a state, a country or a postal code or location pre-selection region etc. Using this input, the first processing device 2.1 can then determine the correct first calibration value and transmit the latter to the scale 3.

In a step 7.8 after the calibration, the first processing device 2.1 conducts a test as to whether a specific, predetermined event has occurred, given the occurrence of which a repetition of the calibration is to be implemented.

As mentioned above, such a predeterminable event can be an arbitrary temporal or non-temporal event. Thus, for example, it can be provided that the event is the reaching of specific, predeterminable points in time. The event can likewise be the occurrence of a specific, predeterminable operating state of the franking machine 2 or of the scale 3. The calibration thus can be repeated, for example, upon each activation of the franking machine 2 and/or of the scale. The event can naturally also be a specific input of a user or from a remote data center.

The event can in particular be the transmission of a new postage rate table by the data center 4. If this is the case, the calibration step 7.7 is repeated with the first calibration value from the new postage rate table. A simple and continuous updating of the calibration thus can be achieved.

Among other things, a consecutive number of the calibration, the date of the calibration, the output signal of the weighing cell at the zero point and the output signal of the weighing cell at the end point are stored in the second area 3.6 of the second memory for documentation of the respective calibration in addition to the gravitational constant g_{FM} received from the franking machine 2.

The second memory 3.3 in total contains n areas 3.5 through 3.7 in which a calibration is respectively protocolled via correspondingly-stored data. To determine the mass m_{FM} of a postal item placed on the platform 3.4 at the site of the franking machine 2, the second processing device 3.1 respectively accesses the data of the last protocolled calibration.

Analogous to this, the first memory 2.3 in total comprises m areas 2.6 to 2.7 in which, among other things, the transmission of the postage rate tables is protocolled via correspondingly-stored data.

Finally, in a step 7.9 it is checked whether the method process should be ended. If this is the case, the method process ends in a step 7.10. Otherwise the method jumps back to the step 7.8.

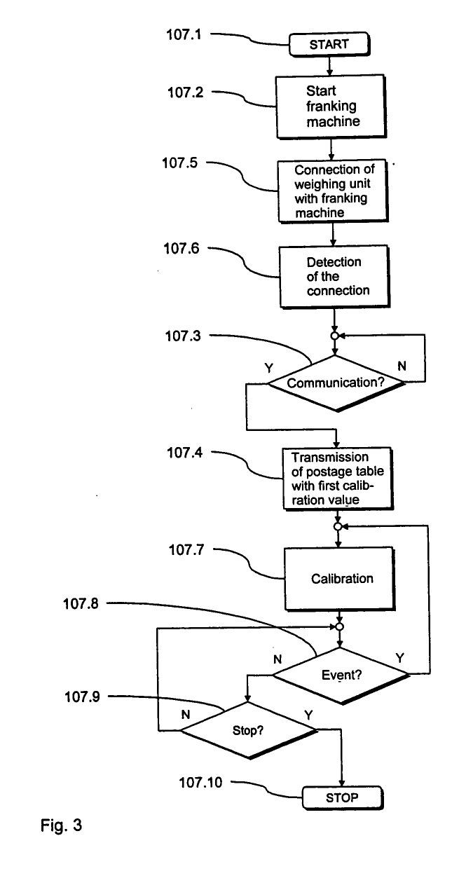

In the following, a further preferred embodiment of the inventive method for equipping a franking machine with a weighing unit, which method can be implemented in the franking arrangement 1, is described with reference to FIGS. 1 and 3.

This method largely corresponds in design and function to that of FIG. 2, such that here only the differences need be discussed. Components identical or at least similar to the embodiment from FIG. 2 are therefore merely provided in FIG. 3 with reference characters increased by the value 100. For these components, the corresponding statements made above apply.

The difference from the embodiment of FIG. 2 is that the workflow of the steps is changed. The processing step 107.5 (with regard to whose content reference is made to the statements above regarding to connection step 7.5) thus first ensues after the activation of the franking machine 2 in the step 107.2.

The detection step 107.6 (the content of which corresponds to step 7.6) subsequently ensues. Triggered by the detection of the connection of the scale 3 with the franking machine 2, it is attempted to establish a communication with the data center 2 via the modem 2.2. If, in the step 107.3, a successful establishment of the connection with the data center 4 is detected, the communication step 107.4 now ensues in which the postage rate table with the embedded first calibration value is transmitted. Regarding the further content of the transmission step 107.4, reference is made to the above statements regarding the transmission step 7.4.

This variant has the advantage that the transmission of the first calibration value only ensues when the scale 3 is actually connected to the franking machine 2. It can thereby be provided that the franking machine 2 was already operated beforehand, but in this case postage rate tables without the first calibration value have been used. It can thus be provided that the integration of the first calibration value into the data center 4 only ensues when the communication ensues in reaction to the connection of the scale 3.

Finally, the calibration step 107.7 then ensues, with regard to whose content reference is again made to the above statements regarding the calibration step 7.7. Furthermore, the workflow then again corresponds to the workflow of the variant of FIG. 2.

The memories described in the preceding can be arbitrary non-volatile memory. For example, one or more EEPROMs can in particular be used for the second memory 3.3. Further, individual data, but preferably all data, are stored in a secure manner. This can ensue in an arbitrary known manner, for example using a checksum or the like.

The present invention was described in the foregoing using examples in which the first calibration value is integrated into a postage rate table, but it is understood that the first calibration value can also be transmitted to the franking machine separately in other variants of the invention.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for equipping a franking machine with a weighing unit, said franking machine comprising a processing device, said method comprising the steps of:
calibrating said weighing unit at a pre-calibration site;
electrically connecting said weighing unit to said processing device of said franking machine;
in said processing device of said franking machine, detecting connection of said weighing unit thereto; and
with participation by said processing device, calibrating said weighing unit for a site at which said franking machine is located, using a calibration value associated with said franking machine and available to said processing device.

2. A method as claimed in claim 1 comprising transmitting said calibration value from a data center, remote from said franking machine, to said franking machine.

3. A method as claimed in claim 2 comprising transmitting said calibration value in a transmission step, and detecting said weighing unit in a detection step, said transmission step preceding said detection step.

4. A method as claimed in claim 2 wherein said calibration value is a first calibration value and comprising transmitting a plurality of calibration values, including said first calibration value, to said franking machine from a data center remote from said franking machine and, with participation of said franking machine, selecting said first calibration value from among said plurality of calibration values.

5. A method as claimed in claim 4 wherein said franking machine has a user interface, and comprising selecting said first calibration value using an input entered by a user via said user interface.

6. A method as claimed in claim 1 wherein said franking machine has an identification associated therewith, and comprising determining said calibration value using said identification.

7. A method as claimed in claim 1 comprising transmitting said calibration value to said franking machine from a data center remote from said franking machine together with a postage rate table provided for calculating franking values.

8. A method as claimed in claim 7 comprising transmitting said postage rate table with a calibration table contained therein that contains at least said calibration value.

9. A method as claimed in claim 1 comprising employing a value as said calibration value selected from the group consisting of a gravitational constant and a correction factor for a gravitational constant.

10. A method as claimed in claim 1 wherein the step of calibrating said weighing unit comprises:
from said weighing unit, supplying first measurement signals, calibrated for said pre-calibration site, to said processing device; and
in said processing device converting said first measurement signals received from said weighing unit into second measurement signals, calibrated for the site of the franking machine, using said calibration value.

11. A method as claimed in claim 1 comprising, upon an occurrence of a predetermined event, repeating calibration of said weighing unit to update calibration of said weighing unit.

12. A franking arrangement comprising:
a weighing unit pre-calibrated for a pre-calibration site;
a franking machine comprising a processing device, said weighing unit being connectable to said franking machine and said processing device detecting connection of said weighing unit to said franking machine; and
said processing device having access to a calibration value, and said processing device participating in calibration of said weighing unit for a site of said franking machine using said calibration value.

13. A franking arrangement as claimed in claim 12 wherein said franking machine comprises a memory connected to said processing device, said calibration value being stored in said memory.

14. A franking arrangement as claimed in claim 13 wherein said calibration value is a first calibration value, and wherein said memory contains a plurality of calibration values including said first calibration value, and wherein said processing device selects said first calibration value from among said plurality of calibration values stored in said memory.

15. A franking arrangement as claimed in claim 14 wherein said franking machine comprises a user interface connected to said processing device, and wherein said processing device selects said first calibration value using input information entered into said processing device via said user interface.

16. A franking arrangement as claimed in claim 12 comprising a data center remote from said franking machine, said franking machine comprising a telecommunication port allowing communication betweens said franking machine and said data center, and said franking machine receiving said calibration value from said data center via said telecommunication port.

17. A franking arrangement as claimed in claim 16 wherein said franking machine has an identification associated therewith, and wherein said data center determines said calibration value using said identification.

18. A franking arrangement as claimed in claim 16 wherein said data center transmits said calibration value together with a postage rate table via said telecommunication port to said franking machine, said franking machine using said postage rate table in said processing device to calculate franking values.

19. A franking arrangement as claimed in claim 18 wherein said data center integrates said calibration value into said postage rate table.

20. A franking arrangement as claimed in claim 19 wherein said data center formulates said postage rate table with a calibration table that comprises at least said calibration value.

21. A franking arrangement as claimed in claim 18 wherein said franking machine comprises a memory, accessible by said processing device, in which said postage rate table is stored together with said first calibration value.

22. A franking arrangement as claimed in claim 12 wherein said calibration value is a value selected from the group consisting of a gravitational constant and a correction value for a gravitational constant.

23. A franking arrangement as claimed in claim 12 wherein said weighing unit supplies first measurement signals, calibrated for said pre-calibration site, to said processing device in said franking machine, and wherein said processing device in said franking machine converts said first measurement signals into second measurement signals calibrated for said site of said franking machine, using said calibration value.

24. A franking arrangement as claimed in claim 23 wherein said processing device in said franking machine repeats calibration of said weighing unit for said site of said franking machine at least once, triggered by at least one predetermined event.

25. A franking arrangement as claimed in claim 12 wherein said processing device is a first processing device, and wherein said weighing unit comprises a second processing device, and wherein said first processing device supplies first calibration values to said second processing device in said weighing unit, and wherein said second processing device in said weighing unit converts said first measurement signals into second measurement signals, calibrated for the site of the franking machine, using said calibration value.

26. A franking arrangement as claimed in claim 25 wherein said second processing device in said weighing unit repeats calibration of said weighing unit for said site of said franking machine at least once, triggered by at least one predetermined event.
